(19) United States
(12) Patent Application Publication
(10) Pub. No.: US 2025/0261783 A1
(43) Pub. Date: Aug. 21, 2025

(54) APPARATUS, SYSTEM, AND METHOD FOR BREWING HIGH CONCENTRATE BREWED COFFEE AND TEA BEVERAGES

(71) Applicant: BUNN-O-MATIC CORPORATION, Springfield, IL (US)

(72) Inventors: Chee Wu Ho, Singapore (SG); Siew Seng Chang, Singapore (SG)

(21) Appl. No.: 19/058,857

(22) Filed: Feb. 20, 2025

Related U.S. Application Data
(60) Provisional application No. 63/555,805, filed on Feb. 20, 2024.

(51) Int. Cl. A47J 31/06; A47J 31/14; A47J 31/44

(52) U.S. Cl. CPC A47J 31/0657; A47J 31/14; A47J 31/446

(57) ABSTRACT

A filter assembly for use with a brewer to form a brewed beverage from a beverage brewing substance. The filter assembly is arranged in a funnel of the brewer and a dose of beverage brewing substance is arranged on the filter assembly within the funnel. A solution is controllably dispensed by the brewer over the beverage brewing substance to form the brewed beverage. A mesh of the filter assembly allows the brewed beverage to pass though the filter assembly. A gasket of the filter assembly engages with an inner surface of the funnel to retain the retain the beverage brewing substance within the funnel against the filter assembly and prohibit the beverage brewing substance from bypassing the mesh of the filter assembly.

### CROSS-REFERENCE TO RELATED APPLICATIONS

This application claims priority to U.S. Provisional Patent Application Ser. No. 63/555,805, filed Feb. 20, 2024, the disclosure of which is incorporated herein by reference in its entirety.

### BACKGROUND

A variety of coffee brewing equipment has been developed over the years to accommodate the particular tastes, cultural preferences, and brewing conditions in different parts of the world. Coffee brewing has developed over many centuries of coffee consumption based on these preferences and styles.

Generally, all beverage brewing techniques take some form of using coffee, tea, or other beverage making substance and combining it with a solution, such as water, and allow the combination to steep. This allows flavors, substances, and characteristics of the beverage making substance to be extracted and transferred to the solution. The term “coffee” will be used for convenience in communication with the understanding that other beverage making substances currently known and hereafter discovered are also included in this discussion. In some techniques the coffee is roasted in a range varying degrees from light to dark. In some techniques the coffee is ground in a range from a course grind to a fine grind. In addition, there are multimode grinds that combine more than one size of coffee grind.

Some techniques use heated water, while other techniques use a range of water temperatures ranging from unheated to cold water. There has been a recent rise in popularity in the making, serving, and consumption of “cold brew” coffee. While water is likely the most common solution used to infuse coffee, other substances ranging from alcohols to milk, to other substances such as coconut water have been used in a variety of recipes. The term solution is not intended to be limited to water, and should be broadly interpreted to include solutions currently known and hereafter discovered for use in making beverages, which are all included in this discussion.

In addition, a variety of filtration systems have been used to allow the beverage created in the infusion process to be separated from the physical coffee material. Such filtration methods include cloth filters, paper filters, metal filters, plastic filters, and other materials. The filtration method can occur using a commonly found drip brew technique in which a funnel structure is formed for retaining a filter material and the filter material is placed within the funnel structure. These filters are typically shaped in a compatible manner to work with the shape of the funnel holding them. The filter shapes are commonly known as “cone-style” or “cupcake-style” primarily depending on the shape of the funnel. The cone-style filter has sloped sides, whereas the cupcake filter generally has a flat bottom and sidewalls extending upwardly from the bottom. Generally these filters are formed as a container that follows the shape of the funnel cavity to contain the brewing material and solution used to infuse the brewing material.

The cavity of the filter material in the funnel receives a dose of coffee. This assembly is attached to a brewing apparatus that controllably dispenses water into the funnel and filter assembly. Alternatively, such an assembly can be placed over a container and water can be manually poured into the assembly.

Other techniques such as the French press have been developed. In this technique, coffee is dispensed into a container that also receives a volume of water. The combined slurry of water and coffee is mixed and allowed to steep for a predetermined period of time. At some point during the brewing process, a mesh plunger is inserted into the container from above and moved downwardly through the container to provide a fluid permeable divider to help separate the beverage from the ground coffee material. The beverage can then be poured off the top of the captive ground material generally retained at the bottom of the container.

Another technique referred to as Vietnamese coffee uses a container referred to as a “phin”. The phin includes a generally cylindrical container having generally vertical sidewalls and a generally flat perforated bottom closing off one end of the cylinder. In some variations of the phin another perforated portion fits in over the coffee placed in the container. The container filter assembly is placed on top of a drinking container for use in creating a single serving of fresh coffee beverage.

In more detail, the generally cylindrical phin container with the perforated bottom is placed over the mouth of the container or “glass”. A charge of ground coffee is placed within the cylindrical container. A cover filter may be placed over the coffee. If a top filter or cover is used, it typically attaches to the container by means of a threaded member extending up through the center of the container. The top filter assembly includes a corresponding threaded receiver. This allows the top filter assembly to be screwed towards the filter assembly in the bottom of the container. This may provide some degree of compaction and retention of the ground coffee so that it does not freely float in the container.

A relatively fine grind of coffee may used in this brewing technique. An initial dose of heated water is dispensed over the coffee to allow the coffee to “bloom.” This first measure of water is allowed to drain through the coffee grounds. An additional dose or two of water can be added to infuse the ground coffee with the water and extract the coffee components from the ground coffee. The infusion from the coffee and water mixture drains through the bottom filter in the cylindrical container into the glass below.

Various techniques associated with this Vietnamese style coffee can be used depending on personal preferences. The type of roast, the size of grind, the temperature of the water and other components can be adjusted to suit personal or local preferences and various recipes.

One of the issues that occurs with regard to this style of coffee is that it is typically configured for individual, single cup doses or preparations. As such, this can be a rather lengthy process. While a lengthy process may be desirable under some settings, other settings may require a larger batch of coffee to be prepared so that it is available for serving multiple customers in a more expedient manner.

There is no known technique, apparatus, or system for producing multi-serving batches of high concentrate coffee similar to that produced in the Vietnamese style.

### BRIEF DESCRIPTION OF THE DRAWINGS

FIG. 1 is a perspective view of a brewer for infusing beverage brewing substance with a solution, such as a combination of ground coffee and water, to produce a brewed beverage and showing that a filter assembly according to an embodiment of the present disclosure is arranged in a funnel of the brewer to support the brewing substance in the funnel and allow the brewed beverage to pass through the filter assembly and out of the funnel to a container, such as a server positioned below the funnel for receiving brewed beverage that flows from the funnel during a brewing cycle;

FIG. 2 is a side elevational view of a brewer of the type as shown in FIG. 1 showing the funnel removed from the hood for receipt of the filter assembly and a dose of brewing substance on the filter assembly, the housing and hood including a water distribution system for controllably dispensing water into the funnel positioned below the hood during a beverage brewing cycle;

FIG. 3 is a top perspective view looking into a mouth of the funnel downwardly along a sidewall of the funnel towards an interior cavity defined by the wall and showing the filter assembly retained within the cavity positioned generally along an inside surface of a bottom wall of the funnel with an outer edge of the filter assembly generally abutting an inside surface of the sidewall;

FIG. 4 is an enlarged perspective view of the filter assembly of FIG. 1 showing the filter assembly includes a support, a mesh portion, a gasket positioned around a perimeter of the support and mesh portion, a stem extending upwardly away from the mesh portion, and a handle attached to the top of the stem portion;

FIG. 5 is an enlarged side elevational view of the filter assembly of FIG. 2;

FIG. 6 is a top plan view of the filter assembly of FIGS. 4 and 5;

FIG. 7 is an exploded perspective view of the filter assembly showing the relative arrangement of the components including the support, mesh portion, gasket, stem, and handle, with the mesh portion positioned on top of the support and the stem extending through the mesh and attaching to the support such as by means of threading, welding, use of a fastener, or other suitable attachment means and showing the gasket having an interior groove therein for positioning the gasket over an outer circumference of the layered mesh and support to retain the gasket thereon;

FIG. 8 is a cross sectional side-elevational view taken along line 8-8 in FIG. 3, with the filter assembly retained within the funnel showing the placement of the mesh and support towards the bottom portion of the funnel with the perimeter gasket, surrounding the support, abutting an inside surface of the funnel towards the bottom portion near the area where the sidewall extends upwardly from the bottom portion, the stem and handle extend upwardly generally from the center of the filter assembly but extend to a position below the mouth of the funnel so as to not interfere with the flow of water into the funnel and also so as to not interfere with the placement of the funnel onto the brewer and removal therefrom; and

FIG. 9 is an enlarged side view of the gasket as shown in FIG. 8 to illustrate an outer edge of the gasket, the gasket providing further engagement between an inside surface of the funnel sidewall and the filter assembly to retain ground coffee within the funnel against the filter assembly and prohibiting it from bypassing the mesh of the filter assembly.

### DETAILED DESCRIPTION

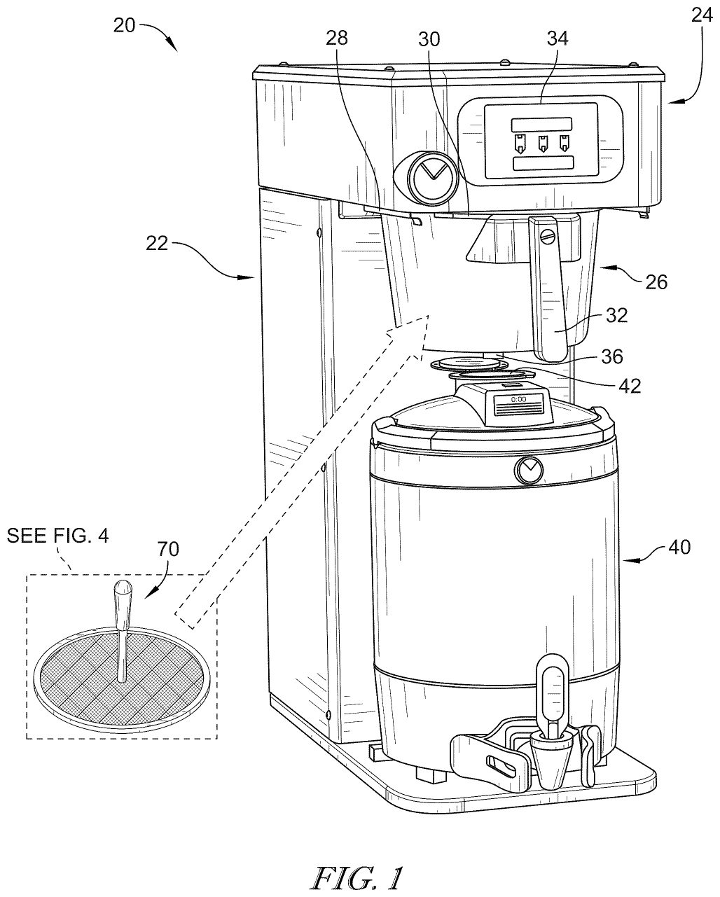

With reference to FIG. 1, a brewer 20 is shown of the type providing a gravity feed brewing technique of generally well-known construction. In this regard, the brewer 20 includes a housing 22, a hood 24 extending outwardly from the housing 22, a funnel 26 retained underneath the hood 24, and a container such as a server 40 positioned below the funnel 26 for receiving brewed beverage that flows from the funnel 26 during a brewing cycle. In an illustrative embodiment of the present disclosure, an exemplary filter assembly 70 is provided and retained in the funnel 26 to receive a dose of ground beverage brewing substance, such as coffee, that is mixed with a solution, such as water, supplied by the brewer 20 to extract various desirable components of the brewing substance for creating a high concentrate brewed beverage that flows through the filter assembly 70 and out of the funnel 26 while the used brewing substance is retained on the filter assembly 70 within the funnel 26. The housing 22 of the brewer 20 contains a collection of components required for the operation of the brewer 20. The hood 24 is illustratively positioned at the top of the housing 22 extending horizontally away from the housing 22. The funnel 26 is positioned below the hood 24 using a pair of spaced apart rails 28 to capture an outwardly-extending flange 30 extending from the funnel 26. A handle 32 is attached to the funnel 26 for allowing an operator to attach the funnel 26 to and remove the funnel 26 from the rails 28 of the hood 24. A user interface 34 such as a display and/or touch screen control is provided in a convenient location on the hood 24 for convenient control and monitoring of the operation of the brewer 20.

During a brewing cycle an operator activates the brewer 20 at the user interface 34 which then initiates a brew cycle having series of steps. Typically, water is heated in a reservoir retained within the housing 22. Controllable mechanisms within the brewer 20 facilitate controlled dispensing of water from a spray head retained within the hood 24. Water is distributed over beverage brewing substance retained within the funnel 26. After combining the solution (e.g., water) and the beverage brewing substance (e.g., ground coffee beans), a brewed beverage extract (e.g., brewed coffee) drains towards the bottom of the funnel 26 and exits the funnel 26 through a drain hole 36 in the bottom, generally in the center of the funnel 26. A server container 40 is positioned below the funnel with an opening 42 of the server container 40 positioned below the drain hole 36 to receive fluid coffee therefrom. The coffee collects within a cavity inside the server 40 for retention and subsequent dispensing from the server 40.

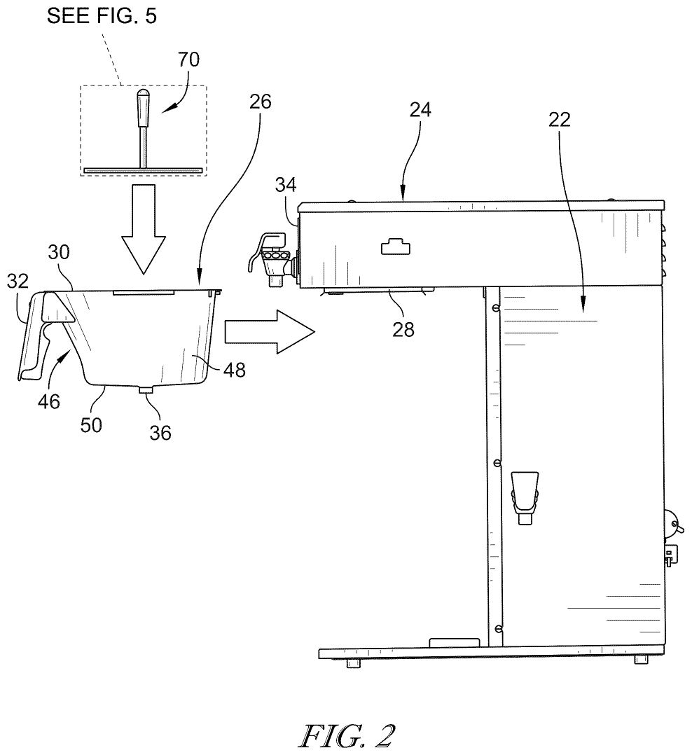

A side elevational view of a brewer identical to brewer 20 of FIG. 1 in all respects relevant to the present disclosure is provided in FIG. 2, and reference to brewer 20 applies equally to the brewer of FIG. 2 and vice versa. The funnel 26 is shown removed from the brewer 20 in FIG. 2 to allow the filter assembly 70 to be positioned within the funnel 26 in preparation for a brew cycle. The server 40 is also removed from the brewer 20 in FIG. 2, but the server 40 may remain positioned on the brewer 20 as the funnel 26 is removed from and placed onto the brewer 20. With the funnel 26 removed from the brewer 20, the filter assembly 70 can be removed from the funnel 26 following a previous brew cycle, cleaned of used brewing substance, and repositioned in the funnel 26.

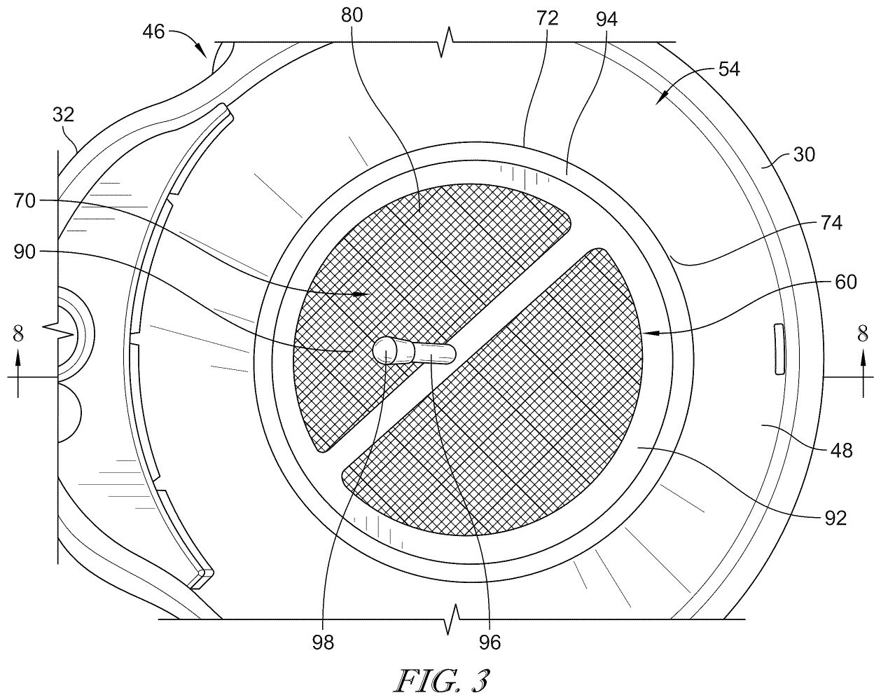

The funnel 26 includes a funnel body 46 with the handle 32 attached to an outside surface of the body 46 as shown in FIG. 2. The funnel body 46 is defined by a sidewall 48, which, with additional reference to FIGS. 3, 8, and 9, forms a generally cylindrical structure. A bottom portion or bottom wall 50 is provided below the bottom edge of the sidewall 48 and attached thereto or otherwise formed therewith such as by metal deformation or plastic molding. The sidewall 48 extends upwardly from the bottom portion 50 and terminates at an upper edge of the sidewall 48 that defines a mouth 54. At the opposite end of the mouth is the drain hole 36, which is formed generally in the center of the bottom wall 50 providing an aperture therethrough which brewed beverage, such as coffee, can flow as it drains downwardly through the beverage brewing substance retained within the funnel body 46 during a brew cycle. The handle 32 and flange 30 can be seen along the outside and upper portions of the funnel 26. The sidewall 48 defines a cavity 60. As shown in FIG. 3, a filter assembly 70 in accordance with an embodiment of the present disclosure is provided and retained in the cavity 60 of the funnel 26. The filter assembly 70 includes an outer edge 72 that generally abuts an inside surface 74 of the sidewall 48. The filter assembly 70 is sized and dimensioned to fit in the funnel body 46 toward the bottom wall 50.

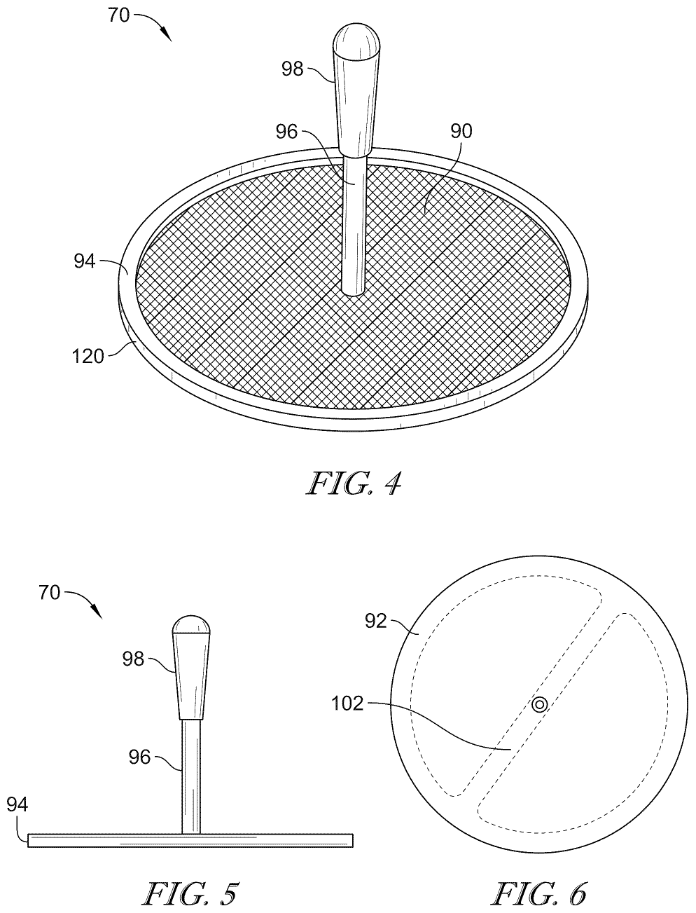

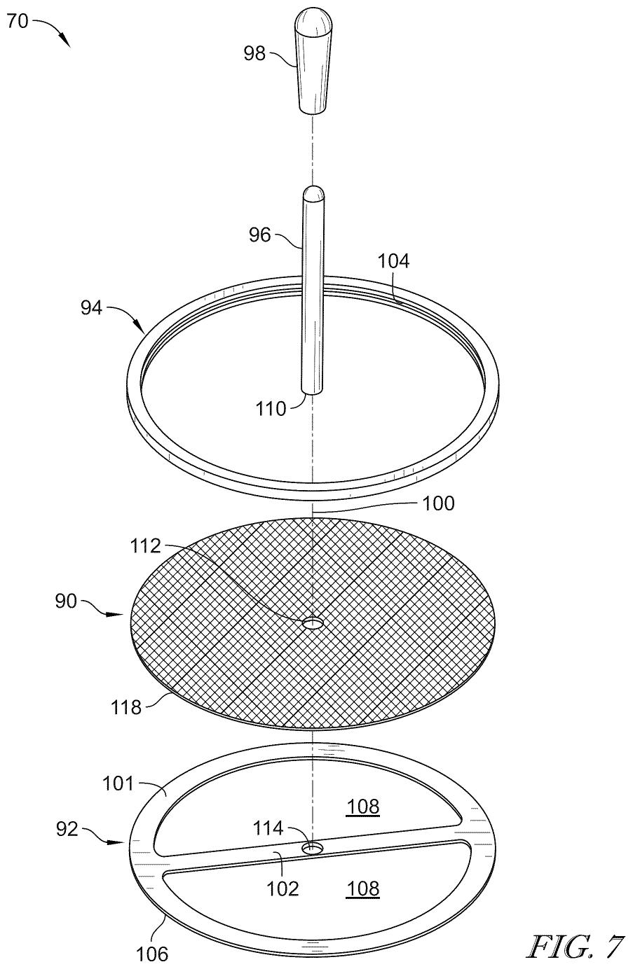

With reference to FIGS. 4-9, details of the filter assembly 70 are described. As shown in FIG. 7, the filter assembly 70 includes a support 92, a filter material or mesh 90, a gasket 94, a stem 96, and a handle 98 generally aligned along a central axis 100 extending through the stem 96 and aligning on centers of the generally circular primary structures of the filter assembly 70. FIGS. 4-6 show various views of the filter assembly 70 as assembled.

The mesh 90 is a generally porous material of a desirable measurement for use in brewing beverages such as coffee from brewing substances. As an example, one version of the mesh 90 could be 40×40 mesh. In some embodiments, the mesh 90 could be 40×40 mesh with a wire diameter of about 0.010 inches to about 0.013 inches defining openings of about 0.015 inches to about 0.012 inches, with a wire diameter of about 0.011 inches defining openings of about 0.014 inches being preferred due to the resulting balances in flow rate through the mesh to not overflow the funnel 26 during brewing and flavor and mouth feel in the brewed beverage by allowing some particulates from the brewing substance to pass through the mesh with the brewed beverage. The range of mesh sizing can be greater or lesser than this measurement. The version of the mesh 90 shown in the present embodiment is generally flexible and support 92 is provided in the filter assembly 70 to provide additional rigidity. It is envisioned that a mesh having greater rigidity could be used and might eliminate the need for an additional component in the form of the support 92. In the illustrated embodiment, the support 92 is a generally rigid circular component having a ring 101 and a spoke 102 extending across the diameter of the support 92. Openings 108 in the support 92 (FIG. 7) are arranged to either side of the spoke 102 to allow passage of brewed beverage through the support 92. In some embodiments, spoke 102 maximizes rigidity of the support 92 and flow rate though the mesh 90 while minimizing areas that may need more thorough cleaning due to overlap with the mesh 90. In some embodiments, one or more additional spokes could be used in support 92 for increased rigidity. The mesh 90 is sandwiched or layered on top of the support 92. In some embodiments, the mesh 90 is secured to the support 92, such as by spot welding at various points in overlapping areas of the mesh 90 and support 92. The gasket 94 includes an interior groove 104 which fits over the outer circumferential edges 106 and 118 of the support 92 and mesh 90, respectively. The gasket 94 is formed of an elastomer, rubber, or otherwise flexible material which allows it to be stretched over the outer edges 106, 118 when assembling the filter assembly 70.

The stem 96 and handle 98 are attached to the support 92 to provide a means for lifting the filter assembly 70 out of the funnel cavity 60 at the end of a brewing cycle. In other words, as described, the beverage brewing substance (e.g., ground coffee beans) is placed in the funnel 26 on top of the filter assembly 70. After water comes in contact with the beverage brewing substance and the brewed beverage (e.g., brewed coffee) is drained from the funnel 26, a quantity of spent brewing substance (e.g., coffee grounds) remains in the funnel 26 and must be removed from the funnel 26 at the end of the brewing cycle. The stem 96 and handle 98 extending upwardly from the center of the funnel assembly 70 facilitates convenient and relatively clean removal of the spent grounds from the funnel 26.

As shown, the stem 96 has a protrusion 110 extending from the bottom thereof that extends through a hole 112 in the mesh and a similarly aligned hole 114 in the spoke 102 of the support 92. Aligned along the central axis 100, the stem can be attached to the spoke 102 by means of a fastener, welding, deformation of the protrusion 110, adhesives, or other techniques such as a complimentary threading on the protrusion 110 and the hole 114. Any number of suitable structures and methods for attaching the stem 96 to the filter assembly 70 is envisioned within the scope of the present disclosure. Once assembled during the manufacturing process the handle 98 can be attached to the top of the stem 96. The handle 98 can be formed of an elastomeric material such as silicone. Use of such a material will help in facilitating convenient removal of the ground coffee from the funnel 26 since the silicone will insulate the operator from residual heat that may collect in the stem 96 and other components of the filter assembly 70. While the present description contemplates using metallic components for the stem 96, mesh 90, and support 92, alternative materials could be used such as plastics, ceramics, silicone, or other materials that provide suitable structural characteristics to provide the function of the filter assembly 70 and are suitably compatible for appropriate use with food substances. In some embodiments, the handle 98 and gasket 94 are removable for cleaning and replacement.

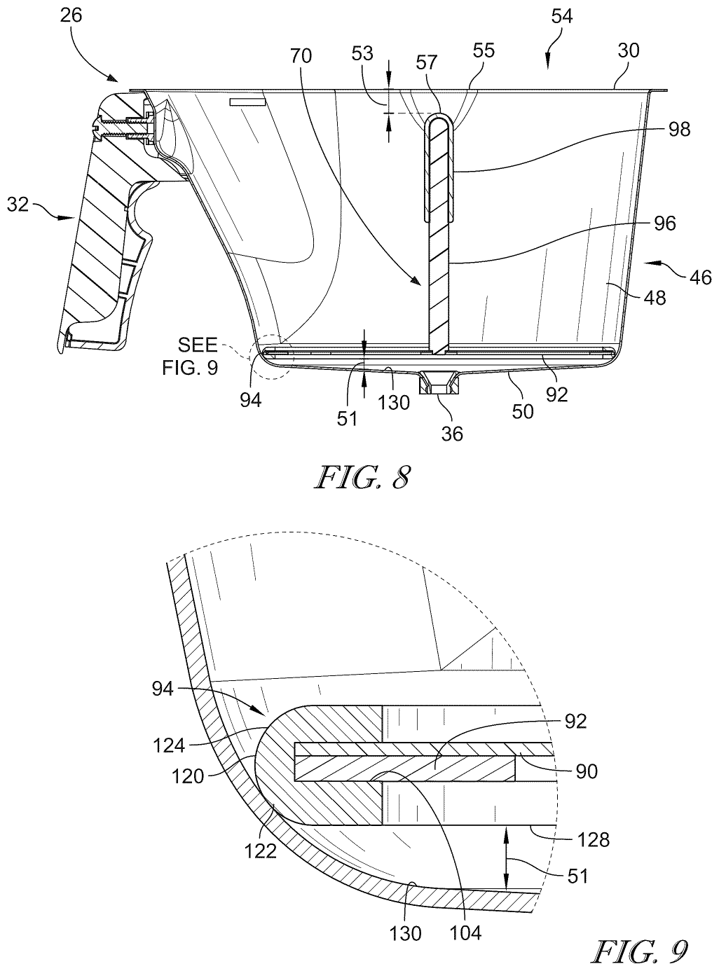

As shown in FIG. 8, the cross section through the funnel 26 further reveals the placement of the filter assembly 70 inside the cavity 60 of the funnel 26. The support 92 and corresponding mesh 90 are generally horizontally disposed towards the bottom portion 50. Placing the filter assembly 70 in this orientation provides a gap 51 between a bottom plane 128 of the filter assembly 70 and an inside surface 130 of the funnel 26. This space 51, provides room for brewed beverage to flow from the filter assembly 70 and collect while flowing towards and through the drain opening 36. In addition, the gasket 94 positioned around the perimeter of the support 92 abuts the inside surface 74 of the funnel 26 to provide engagement between the filter assembly 70 and the funnel 26.

As noted in FIG. 8, a differential dimension 53 is defined between a plane 55 of the mouth 54 of the funnel 26 and a top 57 of the handle 98. This differential space 53 prevents the top 57 of the handle 98 from interfering with the placement of the funnel 26 on the rails 28 of the hood 24 of the brewer 20. In addition, this differential dimension 53 provides some additional space between the top 57 of the handle 98 and a sprayhead of the brewer 20, which is generally positioned centrally above the funnel 26 generally aligned with the drain hole 36 with the funnel 26 mounted on the rails 28 of the hood 24. This helps to further facilitate even and directed distribution of water from the sprayhead into the beverage brewing substance (e.g., ground coffee) retained in the funnel 26 on top of the mesh portion 90 of the filter assembly 70. In addition, the differential dimension 53 is small enough so that at least a portion of the handle 98 extends above the beverage brewing substance placed in the funnel 26 for brewing on top of the mesh 90 of the filter assembly 70. This is because there needs to be some portion of material to grip to remove the filter assembly 70 from the funnel 26 at the end of the brew cycle. The centralized location of the stem 96 on the filter assembly 70 helps to maintain a balanced extraction of the filter assembly 70 at the end of a brewing cycle when it has to carry a full load of spent partially drained brewing substance (e.g., coffee grinds).

As an additional matter, FIG. 9 shows an enlarged side view of the gasket 94 taken along line 8-8 in FIG. 3 showing a slight outward convex edge 120 of the gasket, to help provide engagement with the inside surface 74 of the funnel sidewall 48. The convex edge 120 of the gasket 94 also helps when removing the filter assembly 70 out of the funnel 26. In this regard, while a lower portion 122 of the gasket edge 120 abuts an inside surface 130 of the funnel 26 to prevent bypass, an upper edge 124 is curved away from the inside surface 130 so as not to interfere with the removal of the filter assembly 70. As can also be seen, the groove or channel 104 is formed on the inside surface of the gasket 94 so as to fit over an outside perimeter edge of the support 92. In this regard, since the gasket 94 is formed of an elastomeric material, it can be slightly deformed to fit over the perimeter of the support 92 and retained thereon. The edge 120 can be sized and dimensioned to provide a suitable engagement between the filter assembly 70 and the funnel 26 during a brewing cycle yet not interfere with removal of the filter assembly 70 at the end of a brewing cycle.

The filter assembly 70 is also constructed in a manner that is relatively strong. In other words, the mesh 90, either alone, or in combination with, the support 92 is designed and configured to provide some degree of structural resilience. The reason for this type of structural support can be understood in contrast to other funnel and filter support systems. In prior art funnel and filter support systems, a wire basket type of frame is inserted into the funnel to provide space between the filter paper retained inside the funnel body. Such a wire mesh frame is used to provide the space so that beverage can flow through the filter paper retained on top of the wire mesh basket. If this configuration is not used in the prior art technique, the paper would generally adhere to the inside surface of the funnel and prevent the flow of beverage therethrough. This type of prior art filter structure will not work for the creation of Vietnamese-style coffee.

In accordance with the present disclosure, before the start of a brewing cycle, the filter assembly 70 is placed within the cavity 60 of the funnel 26 with the outer edge generally abutting the inside surface 74 of the funnel 26 as shown in FIGS. 2, 3, 8, and 9. A dose of ground beverage brewing substance, such as ground coffee beans, is dispensed into the cavity 60 on top of the surface of the filter assembly 70 facing upwardly towards the mouth 54 of the funnel 26, such as surface 80 in FIG. 3. The funnel 26 with a dose of beverage brewing substance therein is then placed on the rails 28 of the brewer 20 to position it below a spray head of the brewer 20. Water is controllably dispensed over the dose of beverage brewing substance (e.g., ground coffee) therein to infuse the beverage brewing substance with water to extract various desirable components of the beverage brewing substance for creating a brewed beverage (e.g., brewed coffee). Since the filter assembly 70 is generally engaged with the inside surface 74 of the funnel sidewall 48, brewed beverage must flow through mesh 90 of the filter assembly 70 to collect below the filter and drain through the drain hole 36 of the funnel 26. The filter assembly 70 is used with the funnel 26 to retain beverage brewing substance such as coffee within the funnel 26 during the brewing cycle, yet allowing the brewed beverage to pass through the mesh 90. The filter assembly 70 includes the mesh 90 which is retained within the funnel 26 during the brew cycle to separate brewed beverage from the beverage brewing substance.

During the Vietnamese-style coffee process, a pressure may be applied to the at least partially drained beverage brewing substance at the end of the process. This pressurizing step can be useful to enhance or otherwise contribute to a similar mouth feel and/or other characteristics of the finished beverage, similar to a traditional hand poured single serving Vietnamese-style coffee. When an operator applies pressure to the mostly drained beverage brewing substance (e.g., ground coffee) at the end of the brewing process, using the present structures as disclosed herein, the pressure will be applied to the support 92 and/or mesh 90 components. As a result, these components must have some degree of structural resiliency. If an operator were to try to apply pressure to the prior art wire basket and paper configuration, the paper filter would fail, tearing through the areas between the wire mesh portions, resulting in moist beverage brewing substance falling through the openings and creating a mess within the funnel. The structures of the configuration is set forth herein overcome these issues by providing a reusable mesh 90 and support structure 92 of the filter assembly 70 to withstand pressurization at the end of the brewing process.

The filter assembly 70 of the present disclosure can be used for producing a type of brewed beverage commonly referred to as “Vietnamese coffee”. The use of a filter assembly 70 provides a sieve through which brewed beverage can flow. This is in contrast to other similar filter materials such as paper, synthetic material, cloth, or similar materials which tend to retain most of the “fines” or particulates from flowing there through. In other words, the Vietnamese style coffee characteristically has a relatively higher proportion of suspended particles compared to other drip brew coffee techniques. The other coffee brewing techniques using paper filters or similar filters tends to retain most or at least a higher proportion of the “fines” in the filter providing a “clearer” cup of coffee. However, a characteristic of the Vietnamese style coffee provides a different mouth feel or body as a result of additional fines being dispensed into the coffee beverage.

The filter assembly 70 of the present disclosure provides a way to produce a richer coffee having more fines and body than traditional, clearer drip brew beverages. In addition, the large size of the filter assembly 70 for use in the bottom of a funnel provides the ability for the first time to brew a large batch of Vietnamese style coffee beverage. This overcomes the problems with the characteristic phin-style coffee brewing technique used to produce Vietnamese coffee. The phin-style brewer, as described in the background section of this disclosure, is typically configured for brewing a single cup of coffee at a time. The present disclosure benefits from the ability to control the coffee brewing process using a coffee brewer including controllable features to produce a coffee beverage having different characteristics. In this regard, the mesh material 90 is sufficiently large to allow some portion of fines to pass through the mesh during the brewing cycle. The mesh material 90 is likewise small enough to prevent undesirable levels of particles from passing there through.

1. A filter assembly comprising:
a support;
a filter mesh arranged on the support;
a gasket coupled to outer circumferences of the support and filter mesh;
a stem coupled to the support; and
a handle coupled to the stem.

2. The filter assembly of claim 1, wherein the filter mesh is configured to hold a beverage brewing substance for mixing with a solution to form a brewed beverage, and wherein the filter mesh is configured to allow the brewed beverage to pass through the filter mesh for separation from the beverage brewing substance.

3. The filter assembly of claim 1, wherein a spoke extends across a diameter of the support, and wherein the stem is coupled to the spoke.

4. The filter assembly of claim 3, wherein a hole of the filter mesh is aligned with a hole of the support, and wherein the stem extends through the hole in the mesh and couples to the hole in the support.

5. The filter assembly of claim 1, wherein the support, mesh, and stem are formed from metal, and wherein the handle is formed from an elastomeric material.

6. The filter assembly of claim 1, wherein the gasket has a groove to receive the outer circumferences of the support and filter mesh.

7. The filter assembly of claim 6, wherein the gasket has a convex outer edge.

8. A system for preparing a brewed beverage from a brewing substance, the system comprising:
a brewer configured for controllably dispensing a solution into a funnel of the brewer during a brew cycle; and
a filter assembly comprising:
a support;
a filter mesh arranged on the support;
a gasket coupled to outer circumferences of the support and filter mesh;
a stem coupled to the support; and
a handle coupled to the stem,
wherein the filter assembly is sized to be arranged within the funnel, the filter mesh is configured to hold the beverage brewing substance for mixing with the solution to form the brewed beverage during the brew cycle, the filter mesh is configured to allow the brewed beverage to pass through the filter mesh for separation from the beverage brewing substance for dispensing out of the funnel, and the gasket is configured to engage with an inside surface of the funnel with the filter assembly positioned in the funnel to block the beverage brewing substance from bypassing the filter mesh.

9. The system of claim 8, wherein a spoke extends across a diameter of the support, and wherein the stem is coupled to the spoke.

10. The system of claim 9, wherein a hole of the filter mesh is aligned with a hole of the support, and wherein the stem extends through the hole in the mesh and couples to the hole in the support.

11. The system of claim 8, wherein the support, mesh, and stem are formed from metal, and wherein the handle is formed from an elastomeric material.

12. The system of claim 8, wherein the gasket has a groove to receive the outer circumferences of the support and filter mesh.

13. The system of claim 12, wherein the gasket has a convex outer edge.

14. The system of claim 8, wherein the funnel includes a sidewall extending upward from a bottom of the funnel, and wherein the gasket engages with the sidewall of the funnel to position the filter assembly with a gap between a between a bottom plane of the filter assembly and an inside surface of the bottom of the funnel.

15. The system of claim 14, wherein an upper edge of the sidewall defines a mouth of the funnel, and wherein a differential dimension is defined between a plane of the mouth of the funnel and a top of the handle with the filter assembly arranged in the funnel.

16. A method of preparing a brewed beverage from a brewing substance, the method comprising:
arranging a filter assembly in a funnel of a brewer, the filter assembly comprising:
a support;
a filter mesh arranged on the support;
a gasket coupled to outer circumferences of the support and filter mesh;
a stem coupled to the support; and
a handle coupled to the stem;
arranging the brewing substance on the filter assembly in the funnel; and
controllably dispensing a solution onto the brewing substance arranged on the filter assembly during a brew cycle of the brewer to form the brewed beverage.

17. The method of claim 16, wherein the filter mesh is configured to hold the beverage brewing substance for mixing with the solution to form the brewed beverage during the brew cycle, the filter mesh is configured to allow the brewed beverage to pass through the filter mesh for separation from the beverage brewing substance for dispensing out of the funnel, and the gasket is configured to engage with an inside surface of the funnel with the filter assembly positioned in the funnel to block the beverage brewing substance from bypassing the filter mesh.

18. The method of claim 17, further comprising applying a pressure to the beverage brewing substance at an end of the brew cycle.

19. The method of claim 17, further comprising removing the filter assembly with the beverage brewing substance thereon from the funnel after the brew cycle.
